(19) United States
(12) Patent Application Publication
(10) Pub. No.: US 2022/0304887 A1
(43) Pub. Date: Sep. 29, 2022

(54) MASSAGE DEVICE

(71) Applicant: BIBOTING INTERNATIONAL CO., LTD., TAOYUAN CITY (TW)

(72) Inventors: Po-Chang LIU, TAOYUAN CITY (TW); Li-Pin YUAN, TAOYUAN CITY (TW)

(21) Appl. No.: 17/213,191

(22) Filed: Mar. 25, 2021

(51) Int. Cl. A61H 23/02

(52) U.S. Cl. CPC A61H 23/02; A61H 2201/50; A61H 2201/0235; A61H 2201/12

(57) ABSTRACT

A massage device includes a housing, a massage head, a vibration motor, a control module, a thermoconductive sheet, a heating pad and a thermistor. The massage head is disposed in and exposed from the housing. The vibration motor is disposed in the housing. The control module is disposed in the housing and electrically connected to the vibration motor. The thermoconductive sheet is disposed in the housing. The heating pad is adhered on the thermoconductive sheet and electrically connected to the control module. The thermistor is adhered on the thermoconductive sheet and electrically connected to the control module. When the heating pad is heated up and a temperature change is non-detected by the thermistor, the control module switches off the heating pad.

### BACKGROUND

### Technical Field

The disclosure relates to massage devices, particularly to a massage device with a troubleshooting mechanism of heating.

### Description of Related Art

A related-art massager generally includes a motor and a massage head. The massage head is used for touching a human body to make massage by vibration of the motor. A related-art massager may be heated by a heater to perform hot compressing. However, the heater may be dangerous because the malfunction may scald a user. Thus, how to assist the users to simply and rapidly troubleshoot is an issue to be resolved.

In view of this, the inventors have devoted themselves to the above-mentioned related art, researched intensively and cooperated with the application of science to try to solve the above-mentioned problems. Finally, the disclosure which is reasonable and effective to overcome the above drawbacks is provided.

### SUMMARY

The disclosure provides a massage device with a troubleshooting mechanism of heating.

An embodiment of the disclosure provides a massage device including a housing, a massage head, a vibration motor, a control module, a thermoconductive sheet, a heating pad and a thermistor. The massage head is disposed in and exposed from the housing. The vibration motor is disposed in the housing. The control module is disposed in the housing and electrically connected to the vibration motor. The thermoconductive sheet is disposed in the housing. The heating pad is adhered on the thermoconductive sheet and electrically connected to the control module. The thermistor is adhered on the thermoconductive sheet and electrically connected to the control module. When the heating pad is heated up and a temperature change is non-detected by the thermistor, the control module switches off the heating pad.

An embodiment of the disclosure further includes a power off switch electrically connected between the heating pad and the control module.

In an embodiment of the disclosure, a pair of wires are connected between the heating pad and the control module to electrically connect the heating pad to the control module, and the power off switch is disposed at one of the pair of wires.

In an embodiment of the disclosure, the heating pad and the thermistor are arranged adjacently.

An embodiment of the disclosure further includes a connector head arranged on the housing. The connector head is provided with a tube, and the massage head is provided with a negative-pressure chamber communicating with the tube.

An embodiment of the disclosure further includes a communicating pipe connected between the tube and the negative-pressure chamber and passing through the housing.

In an embodiment of the disclosure, the thermoconductive sheet surrounds the negative-pressure chamber.

In an embodiment of the disclosure, the connector head is further provided with an electric connector electrically connected to the control module.

In an embodiment of the disclosure, the thermistor is a positive temperature coefficient (PTC) thermistor.

The massage device of the disclosure is capable of revealing if the thermistor is loosed by detecting a temperature change through the thermistor and capable of lighting up the warning light to make a user be aware of the malfunction that needs to be repaired. When the control module malfunctions, the control module cannot light up the warning light, the control module may switch off the heating pad by the power off switch. The user may be aware of the malfunction that needs to be repaired through the failure of the heating pad.

### BRIEF DESCRIPTION OF THE DRAWINGS

FIG. 1 is a perspective schematic view of an embodiment of the massage device of the disclosure;

FIG. 2 is an exploded view of an embodiment of the massage device of the disclosure; and

FIG. 3 is a side view of an embodiment of the massage device of the disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

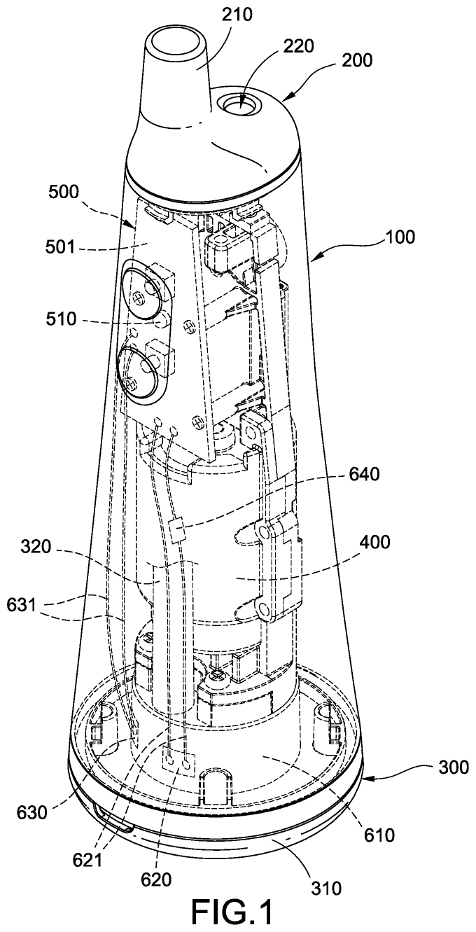

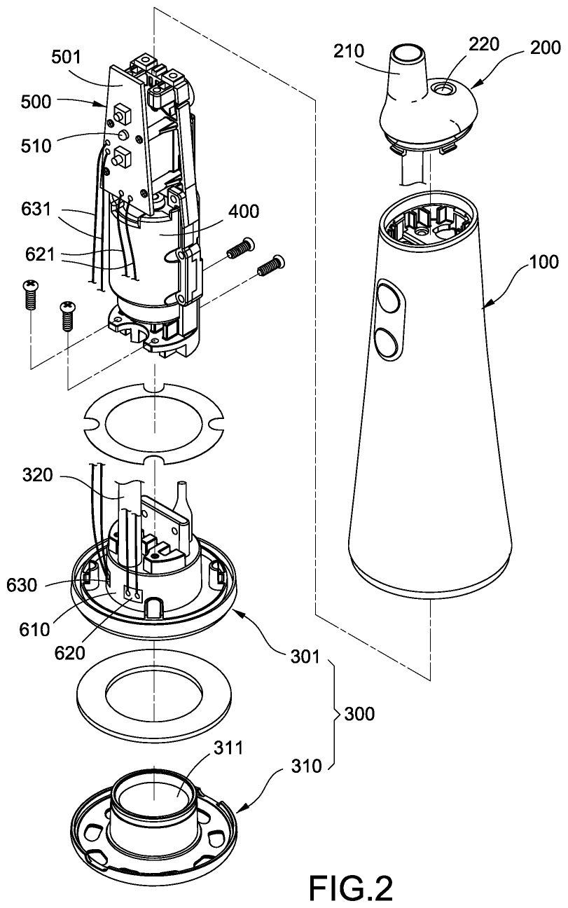

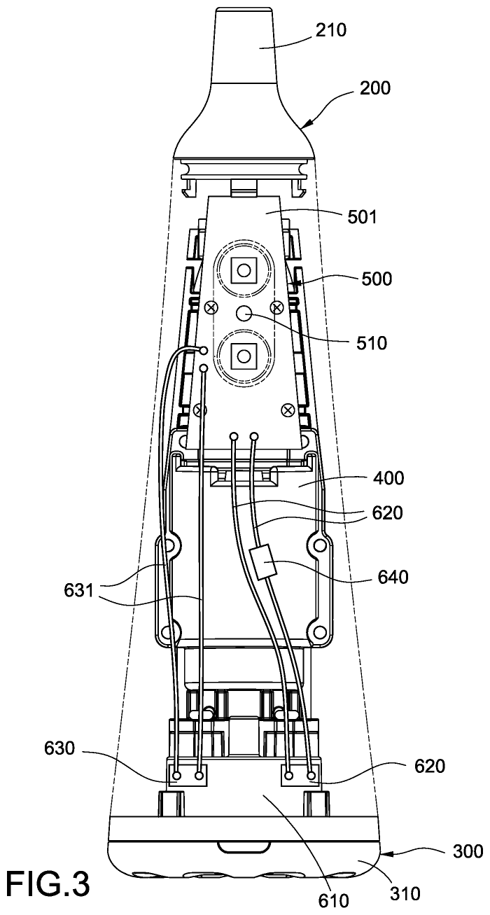

Please refer to FIGS. 1-3, the first embodiment of the disclosure provides a massage device, which includes a housing 100, a massage head 300, a vibration motor 400, a control module 500, a thermoconductive sheet 610, a heating pad 620, and a thermistor 630. In this embodiment, the housing 100 is of a tubular shape for holding, but not limited to this shape. The massage head 300 is disposed in and exposed from the housing 100 for touching a user's skin. In this embodiment, the massage head 300 is disposed on one end of the housing 100. In detail, the massage head 300 includes a base 301 and a plastic cover 310. The base 301 is fixed in the housing 100. The plastic cover 310 is adapted to sheathe the base 301 and exposed from the housing 100 to touch the user's skin. The center of the plastic cover 310 is dented toward the housing 100 to form a negative-pressure chamber 311.

The vibration motor 400 is disposed in the housing 100. The control module 500 is disposed in the housing 100 and is electrically connected to the vibration motor 400. In this embodiment, the control module 500 includes a circuit board 501. The circuit board 501 has a control circuit (not shown in figures) and a warning light 510 electrically connected to the control circuit. The control circuit is electrically connected to the vibration motor 400 to control the vibration motor 400 to operate.

The massage device of the disclosure may further include a connector head 200 for connecting an air pressure source and a power source. In this embodiment, the connector head 200 is arranged on the other end of the housing 100. The connector head 200 is provided with a tube 210. One end of the tube 210 is exposed for connecting a pipeline of the air pressure source and the other end thereof is extended into the housing 100 to communicate with the negative-pressure chamber 311. In this embodiment, the tube 210 and the negative-pressure chamber 311 are connected by a communicating pipe 320 to communicate with each other. In some embodiments, the communicating pipe 320 may be a soft pipe such as, but not limited to, a silicone pipe or a rubber pipe. The connector head 200 may be further provided with an electric connector 220. The electric connector 220 is exposed and is electrically connected to the control module 500 for connecting a power cord to supply electric power to the control module 500 and the vibration motor 400.

The thermoconductive sheet 610 is disposed in the massage head 300. In detail, the thermoconductive sheet 610 is of an annular shape and disposed on the base 301 of the massage head 300, and the thermoconductive sheet 610 surrounds the negative-pressure chamber 311.

The heating pad 620 is adhered on the thermoconductive sheet 610 and electrically connected to the control module 500. A pair of wires 621 are connected between the heating pad 620 and the control module 500 for electrically connecting the heating pad 620 to the control module 500. The control module 500 supplies electricity to the heating pad 620 to heat up the heating pad 620 and conducts and spreads the heat to every place of the massage head 300.

The thermistor 630 is adhered on the thermoconductive sheet 610 and electrically connected to the control module 500. In some embodiments, the heating pad 620 and the thermistor 630 are adjacently arranged to make the thermistor 630 be capable of instantly detecting the operation of the heating pad 620. In this embodiment, the thermistor 630 is a positive temperature coefficient (PTC) thermistor. The temperature and the electrical resistance of the thermistor 630 are positive correlation. A pair of wires 631 are connected between the thermistor 630 and the control module 500 to electrically connect the thermistor 630 and the control module 500.

When the heating pad 620 heats up the thermoconductive sheet 610 to make the thermistor 630 heat up with the thermoconductive sheet 610 to a predetermined temperature, a loop impedance of the thermistor 630 rises so that the control module 500 switches off the heating pad 620 to stop the heating.

Once the thermistor 630 is loosed from the thermoconductive sheet 610 to cause failure of the control mechanism, the heat generated from the heating pad 620 during the heating cannot be conducted to the thermistor 630 through the thermoconductive sheet 610, so the thermistor 630 cannot detect the temperature change. As a result, the control module 500 switches off the heating pad 620 and lights up the warning light 510 on the circuit board 501. Accordingly, the user may be aware of the malfunction that needs to be repaired.

The massage further includes a power off switch 640 which is electrically connected between the heating pad 620 and the control module 500. The power off switch 640 is disposed on one of the wires 621 between the heating pad 620 and the control module 500. When the control module 500 malfunctions, the control module 500 cannot light up the warning light 510. The control module 500 may switch off the heating pad 620 by the power off switch 640. The user may be aware of the malfunction that needs to be repaired through the failure of the heating pad 620.

While this disclosure has been described by means of specific embodiments, numerous modifications and variations could be made thereto by those skilled in the art without departing from the scope and spirit of this disclosure set forth in the claims.

What is claimed is:

1. A massage device comprising:
a housing;
a massage head, disposed in and exposed from the housing;
a vibration motor, disposed in the housing;
a control module, disposed in the housing and electrically connected to the vibration motor;
a thermoconductive sheet, disposed in the housing;
a heating pad, adhered on the thermoconductive sheet and electrically connected to the control module; and
a thermistor, adhered on the thermoconductive sheet and electrically connected to the control module;
wherein when the heating pad is heated up and a temperature change is non-detected by the thermistor, the control module switches off the heating pad.

2. The massage device of claim 1, further comprising a power off switch electrically connected between the heating pad and the control module.

3. The massage device of claim 2, wherein a pair of wires are connected between the heating pad and the control module to electrically connect the heating pad to the control module, and the power off switch is disposed on one of the pair of wires.

4. The massage device of claim 1, wherein the heating pad and the thermistor are arranged adjacently.

5. The massage device of claim 1, further comprising a connector head, arranged on the housing, wherein the connector head comprises a tube disposed thereon, and the massage head comprises a negative-pressure chamber communicating with the tube.

6. The massage device of claim 5, further comprising a communicating pipe, connected between the tube and the negative-pressure chamber and passing through the housing.

7. The massage device of claim 5, wherein the thermoconductive sheet surrounds the negative-pressure chamber.

8. The massage device of claim 5, wherein the connector head further comprises an electric connector electrically connected to the control module.

9. The massage device of claim 1, wherein the thermistor comprises a positive temperature coefficient (PTC) thermistor.

10. The massage device of claim 1, wherein the control module comprises a warning light corresponding to the thermistor, when the heating pad is heated up and the temperature change is non-detected by the thermistor, the control module lights up the warning light.
